(19) United States
(12) Patent Application Publication
(10) Pub. No.: US 2018/0275856 A1
(43) Pub. Date: Sep. 27, 2018

(54) Systems and methods for zooming a selected portion of the graphics layer of a display screen

(71) Applicant: Vizio Inc, Irvine, CA (US)

(72) Inventors: Marcus Apitz, Irvine, CA (US); Peter Schwartz, Irvine, CA (US); Polly Elaine Stecyk, Irvine, CA (US)

(21) Appl. No.: 15/467,834

(22) Filed: Mar. 23, 2017

(51) Int. Cl. G06F 3/0484; G06F 3/0488; G06F 3/0482; H04N 5/445; H04N 21/81; H04N 21/443

(52) U.S. Cl. CPC G06F 3/04845; G06F 3/04886; G06F 3/0482; G06F 2203/04806; H04N 5/44591; H04N 21/8173; H04N 21/4438; H04N 5/44543

(57) ABSTRACT

A zooming display system has multiple numbered zones, and is controlled to select the zones by zone number or by an arrow/navigation key. The zones are zoomed to a larger size. When zoom mode is selected, the system can automatically select a zone based on what is being done on the display at the time of the selection.

### BACKGROUND

Visually impaired television viewers often have trouble reading or viewing electronic display screens such as found on computers and televisions. Computer operating systems such as Microsoft Windows and Apple OS-X allow the viewer, through the use of control keys, to zoom the image being displayed in and out. The methodologies used by Apple allow the option to zoom the image being viewed in the full screen or in a window.

Microsoft uses a methodology that allows a combination of keyboard keys to zoom the image being displayed in and out. Many televisions allow the viewer, through setup menus, to zoom the image. Typically, this feature is invoked when the source content being viewed is a 4:3 aspect ratio and the television is a 16:9 aspect ratio.

### SUMMARY

A problem arises however with digital televisions which have both graphical planes or layers and video planes or layers that can be displayed independently or with the graphics display overlaid on the video plane or layer. Typically the graphic planes are displayed over video being presented to the viewer. Graphical planes typically display setup menus and other user interface information. Graphical planes also typically display a viewer interface for applications such as streaming content applications.

The display of user interface data and viewer interfaces cannot be stretched or zoomed to be larger like video content being displayed. This presents a problem where a visually impaired person attempts to set up features of the display screen using the built in viewer interface.

The inventors recognized that televisions are not just for people to watch video content but also for people that are visually impaired, people who use a television to play music or to stream weather reports, stock prices and other information.

While zooming a portion of a television display screen is not optimal for a visually impaired person to watch a video program, it can be optimal for a visually impaired person to read enlarged user interface data such as menus, stock prices, weather reports, or even banking statements where user interface data is presented on the graphics layer or plane.

Modern digital televisions ranging from 40 inches to 70 inches are now within the reach of everyday consumers. A 15.6 inch laptop has a screen area of approximately 101 sq. in. A 24 inch television has a screen area of approximately 327 sq. in. and a 40 inch television has a screen area of 842 sq. in.

Reading devices for the visually impaired run the gamut of prices ranging from Pepple HD handheld electronic magnifier which as of the writing of this application is around $595 dollars to the Merlin elite low vision device for $3,195 dollars. The numbers of visually impaired people who can afford these high-priced devices diminishes as the price for acquisition moves from the low end device to the high end device.

The inventors recognized that what is needed is some system and/or method to allow the visually impaired person to cause user interface data to be magnified or zoomed and displayed on the graphics layer plane.

The present invention also provides the opportunity for visually impaired viewers to employ the invention to read electronic books and other literature.

### BRIEF DESCRIPTION OF THE DRAWINGS

in the drawings:

FIG. 1A is a depiction of a display screen with five of nine zones identified as zones 1 (16), 3 (18), 5 (20), 7 (22), and 9 (24), where each zone is independently zoomable;

FIG. 1B is a depiction of a display screen with three of nine zones identified as zones 2 (32), 8 (34), and 5 (20), where each zone is independently zoomable;

FIG. 1C is a depiction of a display screen with three of nine zones identified as zones 4 (42), 5 (20) and 6 (44), where each zone is independently zoomable;

FIG. 2 is a depiction of a display screen with setting menu (42) where one setting category (44) has been selected where the category contains three possible settings including zoom mode (54);

FIG. 3A is a depiction of display screen (14) where a series of applications or widgets are shown displayed at the bottom of display screen (14) with APP2 (62) shown being in focus;

FIG. 3B is a depiction of a display screen (14) where a series of applications are shown displayed at the bottom of display screen (14) with display zones 7 (22), 8 (34), and 9 (24) whose outlines are shown as dotted/dashed lines and with APP2 (62) shown being in focus;

FIG. 3C is a depiction of display screen (14) where Zone 7 (22), the bottom left zoom zone, has been zoomed and clue window (182) is shown depicting the zone being zoomed;

FIG. 3D is a depiction of a display screen where focus has been moved from APP2 (62) to APP3 (64) which resides in Zone 8 (34) and clue window (182) is shown depicting the zone being zoomed;

FIG. 4A is a depiction of a menu containing 6 selectable boxes all located on the left side of the display screen and residing across zones 1 (16), 4 (42), and 7 (22) and in which App 3 Setting 1 (92) is in focus;

FIG. 4B is a depiction of the menu after being zoomed with App3 Setting 1 (92) in focus. Note that App 3 Setting 1 (92) resides in Zone 1 (16);

FIG. 4C is a depiction of display screen (14) where focus as been changed from App 3 Setting 1 (92) to App 3 Setting 3 (94) which resides in zone 4 (42) which has been zoomed;

FIG. 5 is a depiction of process flow diagram 130 showing the process flows between viewer 132 and display electronics 134 where viewer 132 is selecting zoom mode from a menu;

FIG. 6 is a depiction of flow diagram 160 showing the process flows between viewer 132 and display electronics 134 where viewer 132 is launching the zoom application by performing a long press on WIDE key 318;

FIG. 7 is a depiction of flow diagram 170 showing the process flows between viewer 132 and display electronics 134 where viewer 132 is selecting a zone for zooming using number keys 316 on hand held remote control device 310;

FIG. 8 is a depiction of flow diagram 180 showing the process flow between viewer 132 and display electronics 134 where viewer 132 is stopping the zoom application and returning the display screen to normal operation;

FIG. 9 is a depiction of hand held remote control device 310 with navigation keys 312, number keys 316, zoom launch/kill key 318, and Select Key 414;

FIG. 10A is a depiction of clue Window 182 depicting zone 1 being zoomed;

FIG. 10B is a depiction of clue Window 182 depicting zone 2 being zoomed;

FIG. 10C is a depiction of clue Window 182 depicting zone 3 being zoomed;

FIG. 10D is a depiction of clue Window 182 depicting zone 4 being zoomed;

FIG. 10E is a depiction of clue Window 182 depicting zone 5 being zoomed;

FIG. 10F is a depiction of clue Window 182 depicting zone 6 being zoomed;

FIG. 10G is a depiction of clue Window 182 depicting zone 7 being zoomed;

FIG. 10H is a depiction of clue Window 182 depicting zone 8 being zoomed;

FIG. 10I is a depiction of clue Window 182 depicting zone 9 being zoomed.

### DETAILED DESCRIPTION

Reference will now be made in detail to various embodiments, examples of which are illustrated in the accompanying drawings. Wherever possible, the same reference numbers will be used throughout the drawings to refer to the same or like parts.

In a first exemplary embodiment, a methodology is disclosed that allows the viewer, once zoom mode is selected and the zoom application is launched, to navigate from one zone to any other zone of the zoom by pressing one of the number keys corresponding to the zone to be zoomed.

In another exemplary embodiment, a methodology is disclosed that allows a viewer to make a selected cell as the default zone initially displayed in zoom mode once the zoom application is invoked.

In another exemplary embodiment, a methodology is disclosed that presents a small clue window for some predetermined period of time to the viewer depicting which zone is currently being zoomed.

In another related embodiment, the clue window is a depiction of the display screen not in the current zoom mode and shows a zoomed view of the current zoom zone.

In another exemplary embodiment, the zone being zoomed is controlled to automatically change as the focus of the objects being zoomed changes. For example, if a table of data is being displayed and the initial focus is for zone 1, the top left zone, and the user navigates down the table to a table item residing in zone 4 (e.g., using the arrow key on the remote control), the middle left zone, the focus for the displayed zone will automatically move to zone 4, the middle left zone. As the viewer continues moving down the list, the focus changes to zone 7, the bottom left zone. The same methodology is used when the focus of objects move horizontally across the display screen.

In another exemplary embodiment, the mechanics of zooming a portion of the graphics plane may be accomplished through the use of software modules. Display screens used as televisions or computer monitors or dual use display screens may also have scaling hardware implemented zoom features which when driven by application software can perform the same zoom functionality as software only modules.

In another exemplary embodiment, the zone that is initially zoomed upon zoom application launch is dependent on the context of the graphical data to be zoomed. See table 1 for a list of likely defaulted zoom zones based on context:

TABLE 1

| Context/Graphic Element | Zone |
|---|---|
| Sidebar | 1 |
| Full Screen Application | 1 |
| Channel List | 5 |
| Picture Mode (PIC Key) | 5 |
| User Manual | 1 |
| Multi Media Player | 1 |
| Info Bar | 2 |
| Input Drop Down Menu | 2 |
| Wide Drop Down Menu | 2 |
| Dialog Box | 5 |
| Warnings & Notifications | 5 |
| PIN Entry | 5 |
| Picture Size & Pic Adjustment | 5 |
| Equalizer Adjustment | 5 |
| Application Dock | 8 |
| Volume Adjustment | 8 |
| Picture Adjustment Sliders | 8 |
| Audio Adjustment Sliders | 8 |
| Color Tuner Adjustment | 8 |
| Full Screen Apps | Varied |
| | By App |

Note that this table shows default zones for multiple actions being carried out on the display screen including at least viewing a video program, viewing and/or adjusting a mode of display, viewing an application running on the display screen, and viewing and adjusting characteristics of the display. Other actions can of course be accommodated by associating the action, and the location that the action will likely occur on the screen, with.

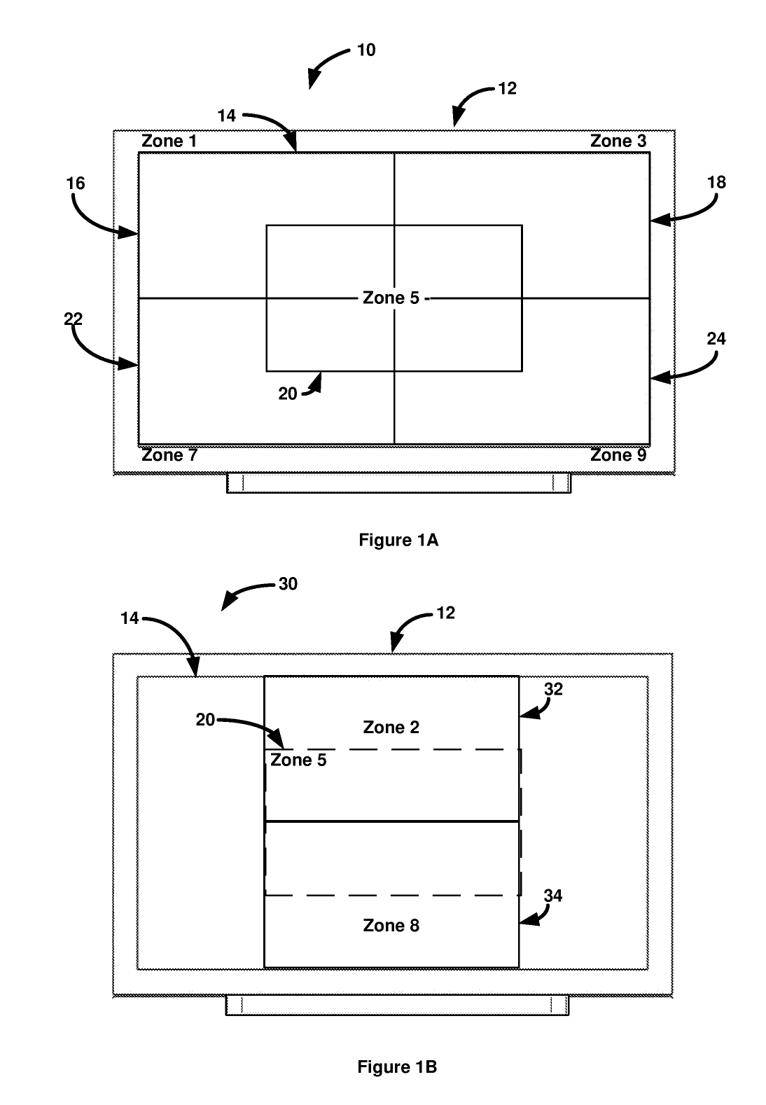

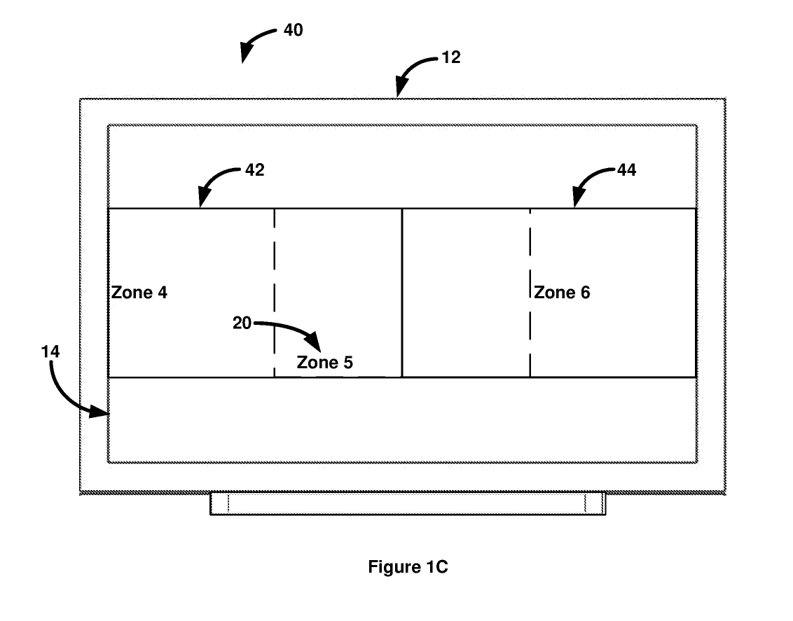

Now referencing FIG. 1A where 10 depicts display screen device 12 and display screen 14 showing 5 of 9 zoomable windows/objects. FIGS. 1A, and 1B and 1C collectively show the non-zoomed locations of the various zones that can be zoomed. Note that in FIG. 1A, that zone 5 (20), is located in the center of display screen 14, and overlaps zones 1 (16), 3 (18), 7 (22), and 9 (24).

Also notice that in FIG. 1B that zones 2 (32) and 8 (34) overlap some portion of the other zones that are zoomable. Similarly, in the horizontal direction, zones 4 (42) and 6 (44) overlap zones 1 (16) and 3 (18) above and zones 7 (22) and 9 (24) below as well as zone 5 (20) which is directly in the center of the display screen. Navigating using the navigating key thus moves the zoomed zone between different zones that overlap, zooming a different area of the screen that overlaps partially, with a previously zoomed area of the screen. In one embodiment, the overlap between adjacent zones is 50% or more, that is, 50% (or more) of zone 2 is shown as the top half of zone 5.

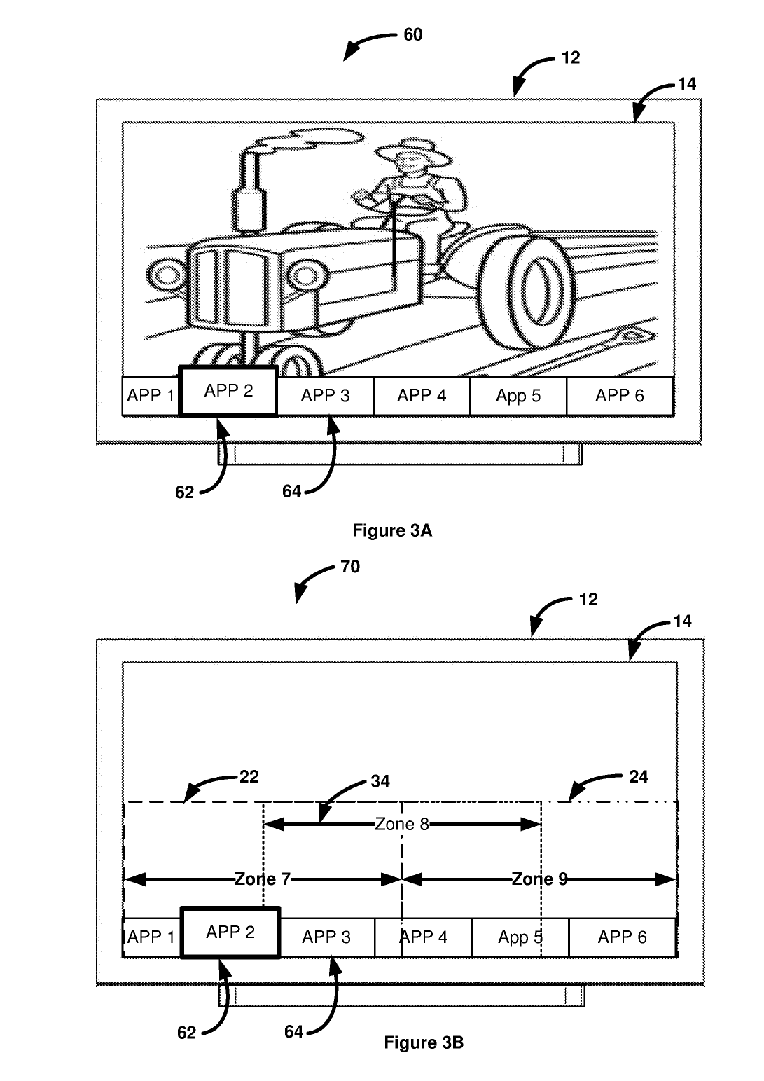

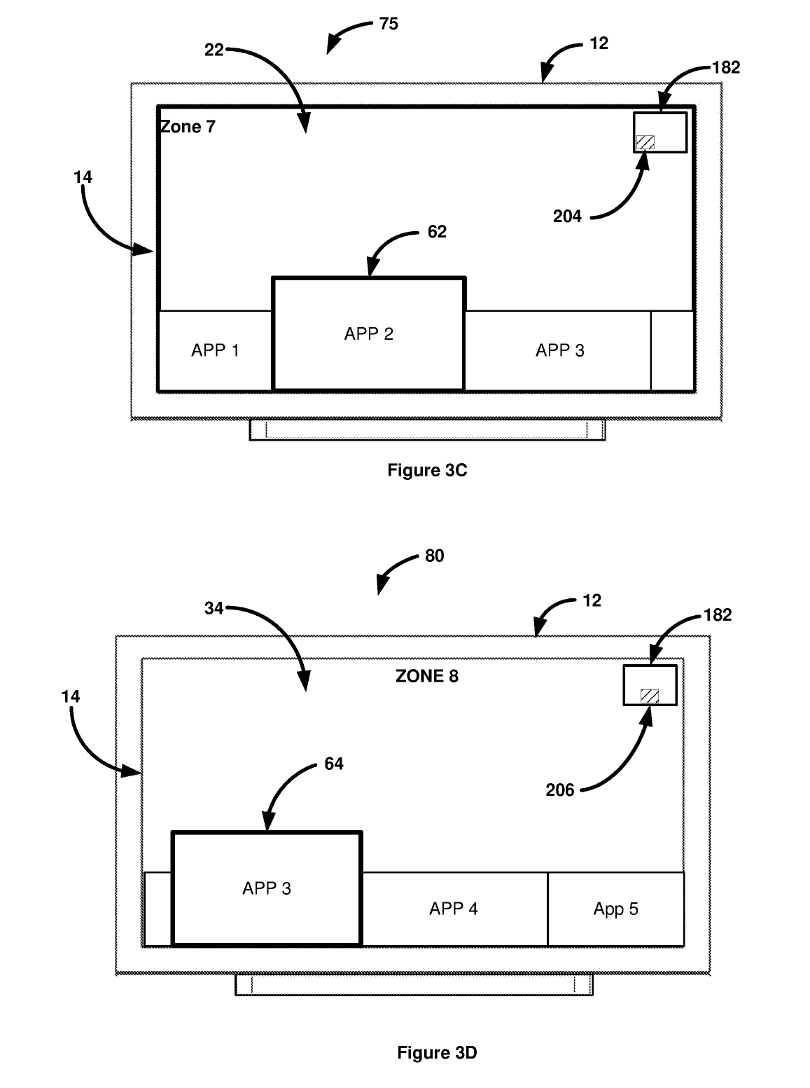

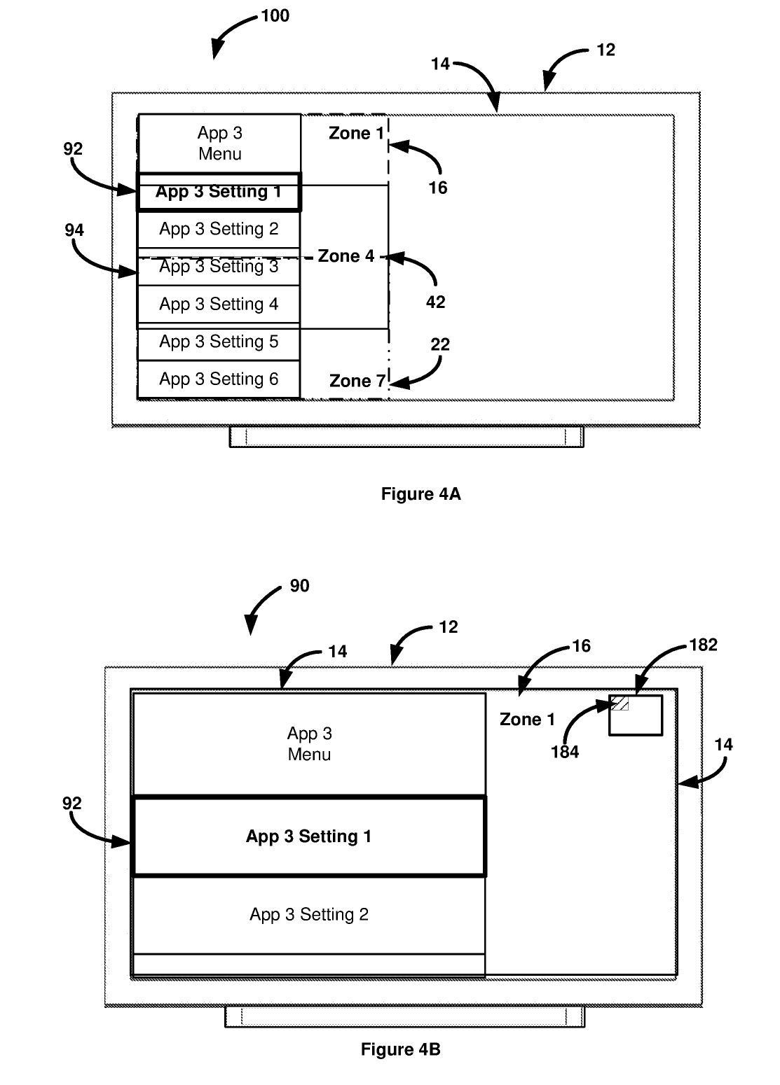

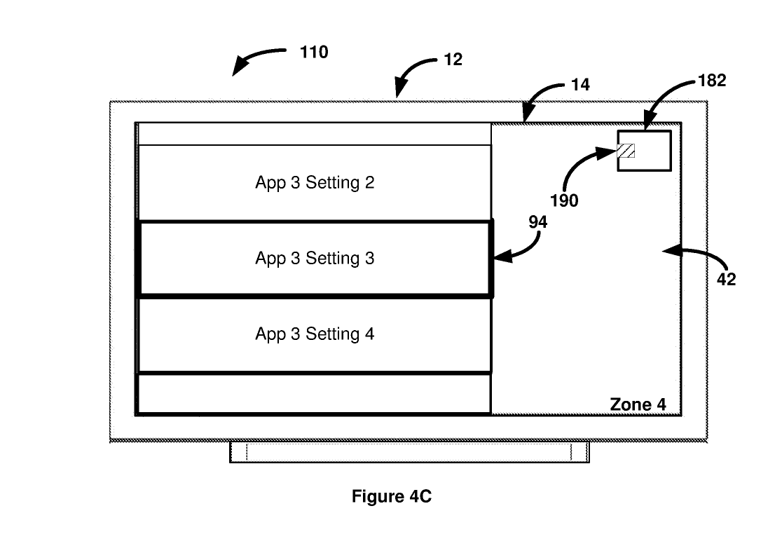

The pattern of the zoomable zones was chosen for this implementation because the patterns allow graphical data to be zoomed and the zoomed user interface data moved about from one zone to another in a smooth manner. See FIGS. 3A-3D and 4A-4C.

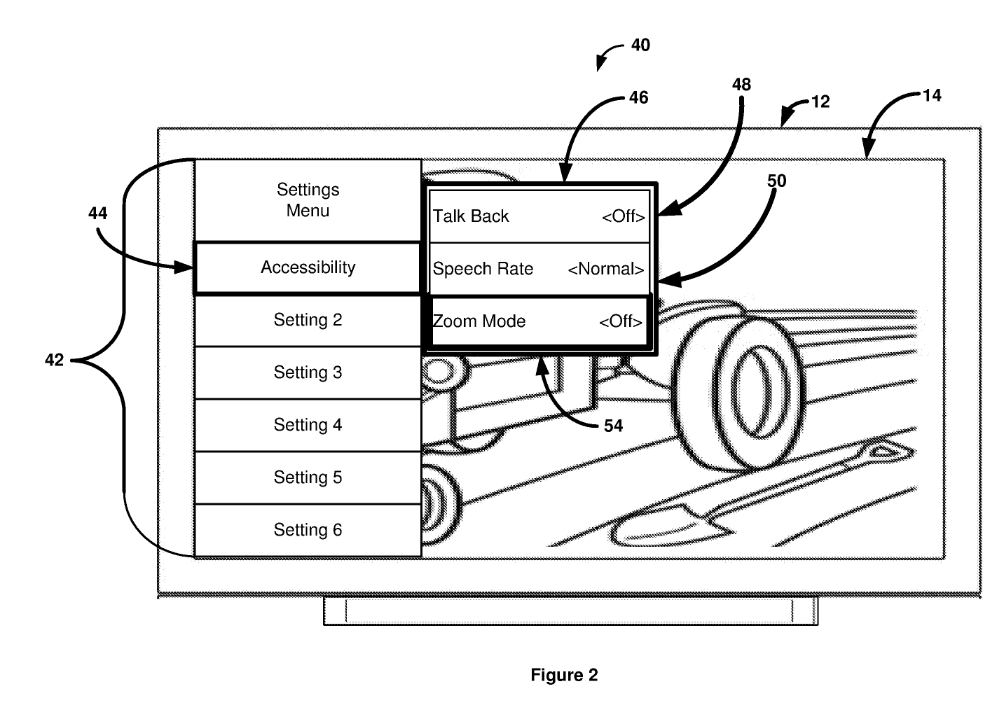

Now referencing FIG. 2 where 40 depicts display screen device 12 and display screen 14 showing system menu 42 with accessibility selection 44 showing three sub-selections 46. Sub selections 46 include talk back mode 48, speech rate selection 50 and zoom mode selection 54. In this depiction, zoom mode selection 54 is in focus (heavy border line) and is shown as being turned off (its preselection state). The user may invoke zoom mode by changing “Off” to “On”. The user may also invoke zoom mode, if it is currently in an off state, by holding down the “WIDE” key 318 on the hand held remote control device 310 for some predetermined period of time, for example 5 seconds. Conversely, if zoom mode is currently enabled, it may be disabled or turned off by either disabling it in system menu 42 or by holding down the “WIDE” key 318 on the hand held remote control device 310 for some predetermined period of time, again, for example 5 seconds.

Now referencing table 1 where a typical table of applications, adjustments, and dialog input boxes show the default zone to be zoomed when initial launch of the zoom application (not shown) is performed. Table 1 shows allowing the default zone to be picked based on the context of what will be in the zone that is to be zoomed.

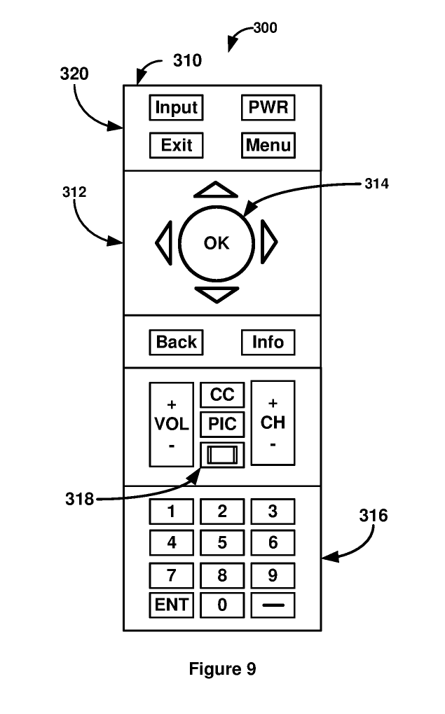

Now referencing FIG. 9 where 300 depicts hand held remote control 310. In this depiction, a set of navigation buttons 312 is depicted and a set of number keys 316 is depicted as well as launch and stop zoom application key 318 being depicted. Key 318 is also referred to as the “WIDE” key which when pressed changes the aspect ratio of the video being shown in display 14. In these depictions, the arrow buttons allow a viewer to navigate menu settings, application settings, and other such settings. For example, this can control those shown in FIG. 2 while number keys 316 allow a viewer to select individual zones to be displayed in zoom mode.

WIDE Key 318 is the launch zoom application key. This key is selected to launch the zoom application if the user chose not to use the method described for FIG. 2 to launch the zoom mode. If zoom mode has already been enabled (FIG. 2) or the WIDE Key 318 was used to enable zoom mode, the user can perform a long touch of WIDE key 318 to launch the zoom application. This action will cause the default zone to be zoomed on display screen 14. Repeating a long touch once the zoom application has been launched causes the zoom application to be stopped. For the purpose of this disclosure, a long touch is some predetermined period of time, such as 5 seconds.

Number keys 316 allow the user, once zoom mode is enabled (FIG. 2) or after initial launch, via WIDE key 318, to select a particular display zone (1-9) to be zoomed. For example, if the user wants to zoom zone 1 (16), the user would press the “1” button/key. If the user wants to zoom zone 9 (24), the user would press the “9” button/key.

Now referencing FIG. 3A where 60 depicts display device 12 and display screen 14. A set of applications are shown at the bottom of display screen 20 as App 1 through App 6. Note that in this depiction, App 2, 62, is shown in focus by being larger than the other apps and with a bolded border than the boxes depicting applications 1 and 3-6.

Now referencing FIG. 3B where 70 depicts display device 12 and display screen 14. In this depiction, applications App 1 though App 6 are shown with the bottom three zoomable zones, zone 7 (22), zone 8 (34), and zone 9 (24) that the Apps reside in. In this depiction, Apps 1-6 all reside within the bounds of zones 7 (22), 8 (34), and 9 (24) before zooming. Note that in this depiction, zone 7 (22) is the left most bottom zone and covers one quarter of the space of display screen 14 as does zone 9 (24) and zone 8 (34) occupies one half of zone 7 (22) and zone 9 (24).

On an actual display screen, the dotted lines denoting zoomable zones are not visible. The dotted lines denoting zoomable zones in FIGS. 3B and 4B are for the purpose of clarity in the figures only.

Now referencing FIG. 3C where 75 depicts display screen device 12 and display screen 14. In this depiction, zone 7 (22) is shown after being zoomed filling display screen 14. Note that in this depiction, only part of App 1 and all of App 2 (62) and App 3 (64) is shown. In this depiction, zone 7 (22) has been zoomed to 200% filling the display screen. The actual scale that a zone can be zoomed is not limited to 200%. In actual practice the scale may be larger or smaller than 200%. Also note in this depiction, clue window 182 is being displayed showing that zone 7 (22) is depicted by the small replica 204 representing zone 7 (22).

Now referencing FIG. 3D where 80 depicts display screen device 12 and display screen 14. In this depiction, the user has move the focus from app 2 (62) to app 3 (64). App 3 (64) resides in zone 8 (34). In this depiction Zone 8 (34) has been zoomed to 200% full screen and clue window 182 and is being displayed showing that zone 8 (34) is depicted by the small replica (206) representing zone 8 (34).

Now referencing FIG. 4A where 100 depicts display screen device 12 and display screen 14. In this depiction, App 3 Setting 1 (92) and App 3 Setting 3 (94) are shown with App 3 Setting 1 (92) currently in focus. Also note that zones 1 (16), zone 4 (42), and zone 7 (22) are shown in dotted lines for clarity. The dotted lines denoting zoomable zones in FIGS. 3B and 4A are for the purpose of clarity only. Also note that in this depiction, the zoom application (not shown) has not been launched.

Now referencing FIG. 4B where 90 depicts display screen device 12 and display screen 14. In this depiction, zone 1 (16) is zoomed with App 3 Setting 1 (92) and App 3 Setting 2 being zoomed 200% filling the display screen. Also shown in this depiction is clue window 182 being displayed showing that zone 1 (16) is depicted by the small replica (184) representing zone 1 (16). Note that App 3 Setting 1 (92) is in focus as shown by App 3 Setting 1 (92) having a bolded border.

Now referencing FIG. 4C where 110 depicts display screen device 12 and display screen 14. In this depiction, the user has navigated to App 3 Setting 3 (94) currently in focus. Zone 4 (94) has been zoomed 200% to fill display screen 14 and clue window 182 and is being displayed showing that zone 4 (42) is depicted by the small replica (190) representing zone 4 (42).

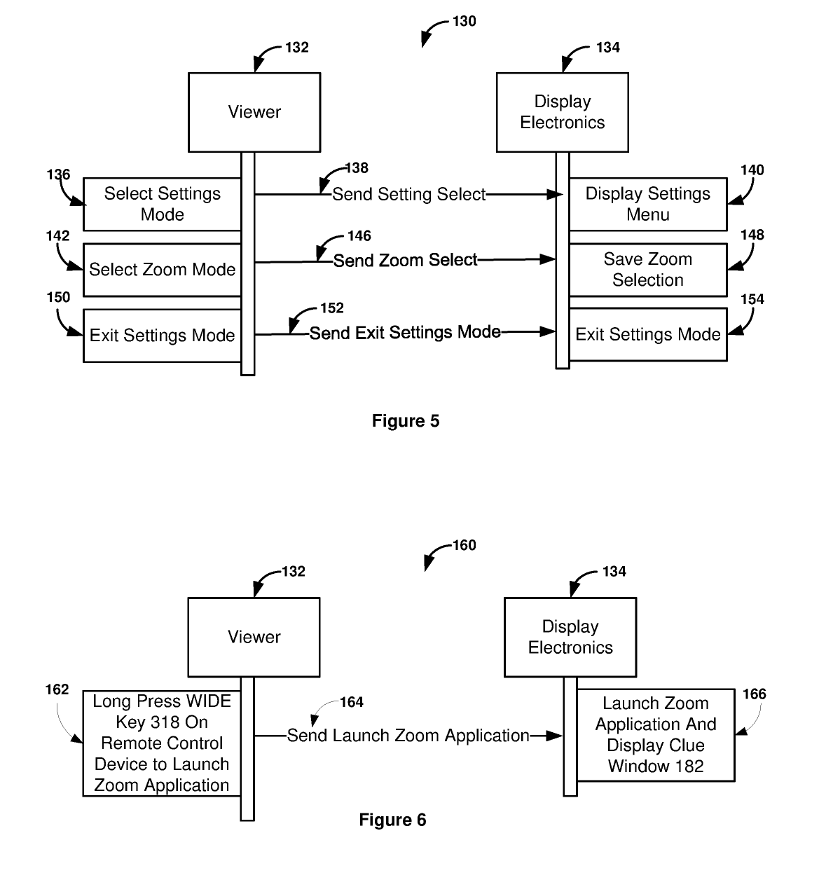

Now referencing FIG. 5 where 130 depicts a process flow where the processes used by viewer 132 and display electronics 134 are shown for enabling zoom mode using system menu 42. In this depiction, the process starts with viewer 132 and process block select settings mode 136. This process block allows viewer 132 to send signal 138 send setting select to display electronics 134 process block 140 display settings menu. This process block launches the system setting menu (FIG. 2). The display electronics can include the electronics such as display drivers, processors and other devices that produce electronic outputs that are displayed on the display unit itself.

Viewer 132 then executes process block 142 select zoom mode whose initial state is “Off”. Process block 142 sends signal 146 send zoom select to process block 148 save zoom selection. This process block enables zoom mode which waits for the user to launch the zoom application (not shown). After selecting zoom mode, viewer process falls through to process block 150 exit settings menu. This process block sends signal 152 to process block 154 exit settings mode. This process exits the setting mode and returns the display screen to normal display mode.

Now referencing FIG. 6 where 160 depicts a process flow where the processes used by viewer 132 and display electronics 134 are shown for an alternate method of launching the zoom application (not shown). In this depiction, the process starts with viewer 132 and process block 162 long press Wide key 318 on hand held remote control device 310, FIG. 9, to launch zoom application. This process block sends signal 164 send launch zoom application to process block 166 launch zoom application and display clue window 182. This process block launches the zoom application and display the default zone as set by context shown in table 1 as the zoomed zone.

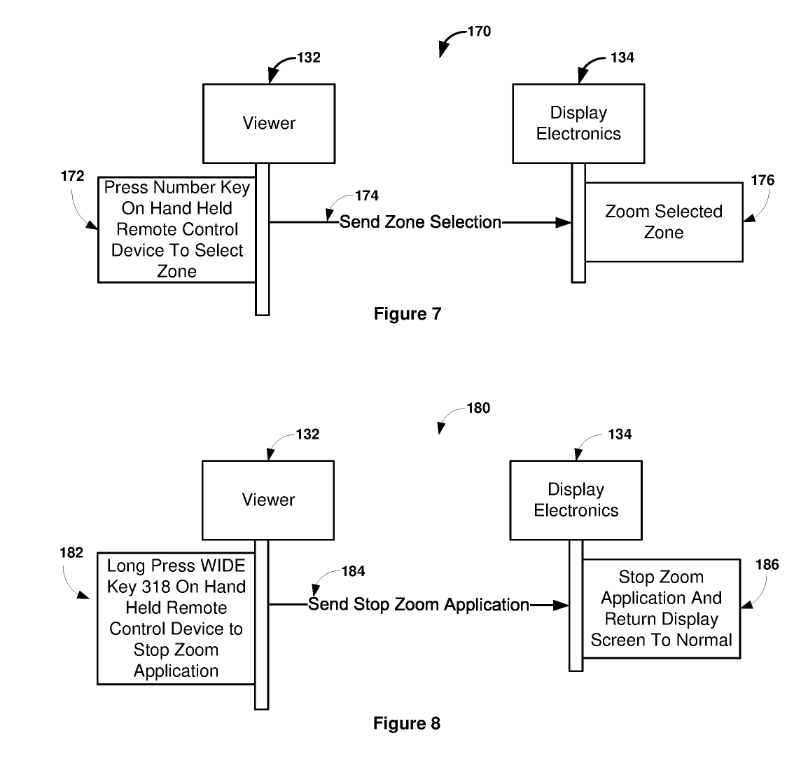

Now referencing FIG. 7 where 170 depicts a process flow where the processes used by viewer 132 and display electronics 134 shown for selecting a different zone to be zoomed once any one zone is currently zoomed. In this depiction, the process starts with viewer 132 and process block 172 press number key on hand held remote control to select a zone. This process block transmits a numbered key being pressed after which signal 174 send zone selection is sent to process block 176 zoom selected zone. This process block changes the zone currently being zoomed to the zone selected by viewer 132.

Now referencing FIG. 8 where 180 depicts a process flow where the processes used by viewer 132 and display electronics 134 are shown for how the viewer terminates the zoom application (not shown). In this depiction, the process starts with viewer 132 and process block 182 long press WIDE key 318 on remote to stop zoom application. This process block sends signal 184 send stop zoom application to process block 186 stop zoom application and return display to normal.

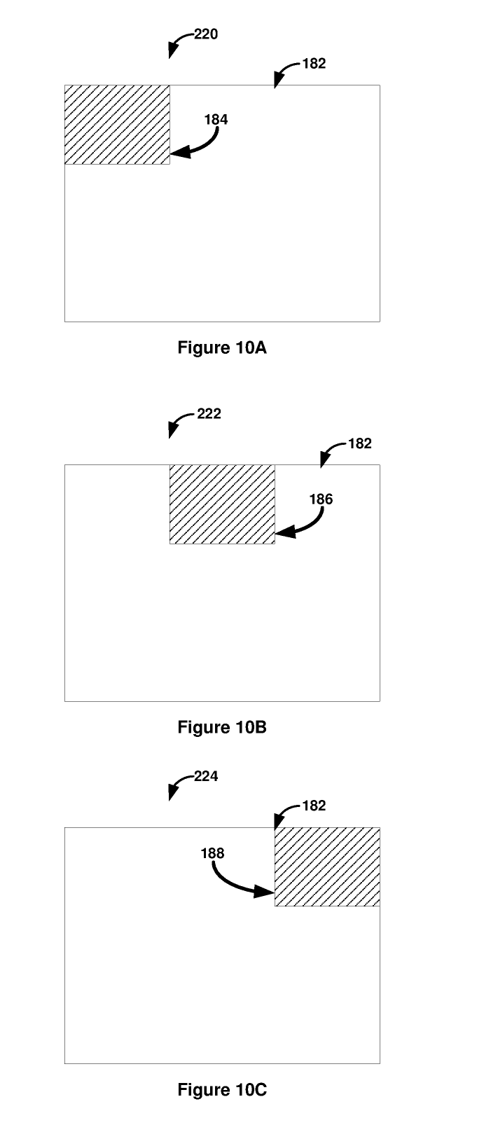

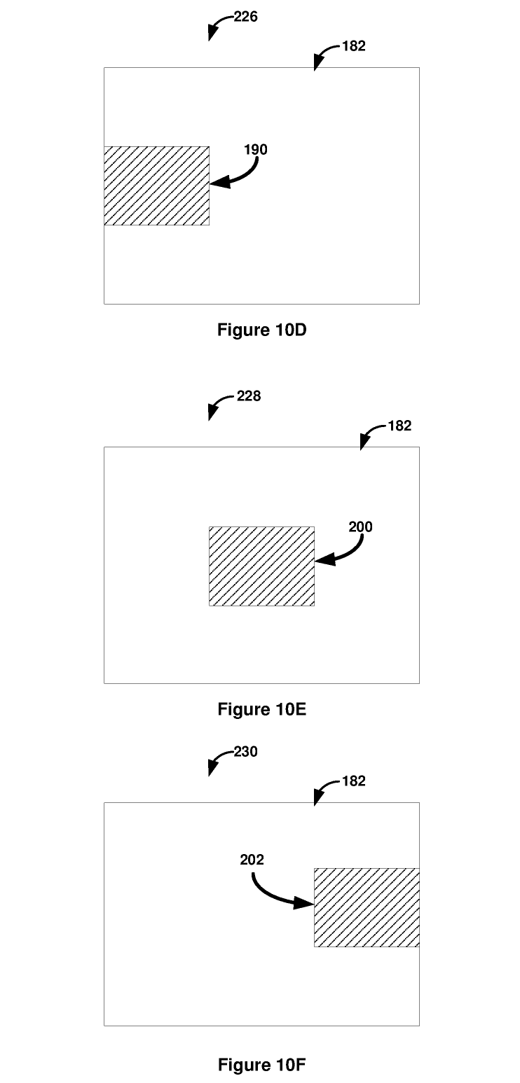

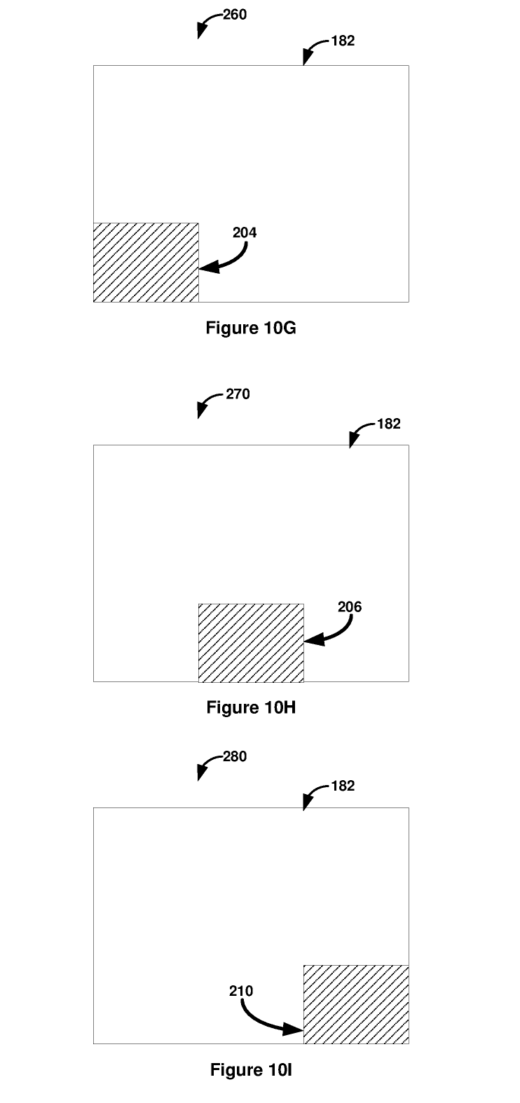

Now referencing FIGS. 10 A through 10 I. These figures depict clue Window 182 which is displayed on initial launch of a zone for a predetermined period of time when the zone is first displayed or when the zone is changed by the user. When the predetermined period of time expires, clue Window 182 is removed from the display.

FIG. 10A depicts clue window 182 for, zone 1 (16) represented by 184. The clue window depiction shows the selected zone as being located in the upper left corner of display screen 14.

FIG. 10B depicts clue window 182 for, zone 2 (32) represented by 186. The clue window depiction shows the selected zone as being located in the upper middle of display screen 14.

FIG. 10C depicts the clue window for, zone 3 (18) represented by 188. The clue window depiction shows the selected zone as being located in the upper right corner of display screen 14.

FIG. 10D depicts the clue window for zone 4 (42) represented by 190. The clue window/object depiction shows the selected zone as being located on the middle left side of display screen 14.

FIG. 10E depicts the clue window for zone 5 (20) represented by 200. The clue window depiction shows the selected zone as being located in the center of display screen 14.

FIG. 10F depicts the clue window for zone 6 (44) represented by 202 The clue window/object depiction shows the selected zone as being located on the middle right side of display screen 14.

FIG. 10G depicts the clue window for zone 7 (22) represented by 204. The clue window depiction shows the selected zone as being located in the lower left corner of display screen 14.

FIG. 10H depicts the clue window for zone 8 (34) represented by 206. The clue window depiction shows the selected zone as being located on the bottom middle of display screen 14.

FIG. 10I depicts the clue window for zone 9 (24) represented by 210. The clue window/object depiction shows the selected zone as being located in the lower right corner of display screen 14.

Note also that the above has described operation with a digital television. However, more generally, this can be used on any kind of device that displays videos, such as television sets, Set top boxes, Game consoles, Tuner dongles, Personal computers, and any other device having the ability to display AV content.

Those of skill would further appreciate that the various illustrative logical blocks, modules, circuits, and algorithm steps described in connection with the embodiments disclosed herein may be implemented as electronic hardware, computer software running on a specific purpose machine that is programmed to carry out the operations described in this application, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments.

The various illustrative logical blocks, modules, and circuits described in connection with the embodiments disclosed herein, may be controlled by a general or specific purpose processor, or with hardware that carries out these functions.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A display system, comprising:
a display, having a display area, and showing a display on said display area; and
a control that controls selecting zones on the display for zooming to a larger magnification, each zone being selected by using said control, and
each zone being smaller in size than the size of the display, a zone being selected to enlarge the area of the zone to magnified size that enlarges the zone to more fully fill the display area;
each zone overlapping by a specified amount with at least one adjacent zone which is adjacent on the display area to each said zone, so that each two adjacent zones magnify the overlapping amount of the display; and
each said zone being labeled with a zone number,
where said control enables selecting zones on the display by receiving a zone number.

2. The system as in claim 1, wherein said control further enables selecting zones on the display by receiving data from a navigation key to navigate horizontally and vertically on the display, where each press of the navigation key selects an adjacent zone which is overlapped with a previously-selected zone.

3. The system as in claim 2, wherein the navigation key includes controls from arrow keys in multiple directions.

4. The system as in claim 1, where each zone overlaps with an adjacent zone by 50%, such that each zone and another adjacent zone overlap in display area by 50%.

5. The system as in claim 1, wherein the display being shown has different functions, and the control receives a selection of a zoom mode, where the zoom mode starts with a default setting that selects one of said zones as a function of which of said different functions are being shown on the display area.

6. The system as in claim 5, wherein the different functions on the display include at least viewing a video program, viewing a mode of display, adjusting a mode of display, viewing an application that is being executed by a computer associated with the display, and adjusting characteristics of the display.

7. The system as in claim 6, further comprising a memory storing a table, the table including multiple different functions including said different functions, and each said function associated with a default zone on the display which is likely to be desired to be zoomed for each function.

8. The system as in claim 1, further comprising a clue window being shown on the display when a zoom mode is selected, the clue window showing an indication of the display and an indication of a portion of the display which is being zoomed.

9. The system as in claim 8, wherein the clue window is shown for a specified number of seconds, and disappears after the specified number of seconds.

10. The system as in claim 5, where the display enables displaying multiple different applications which are running on a computer associated with the display, and where each of the applications includes a default zone for zooming, where a default zone for zooming for a first of said applications is different than a default zone for zooming of a second of said applications.

11. A display system, comprising:
a display, having a display area, and showing a display on said display area; and
a control that controls selecting zones on the display for zooming to a larger magnification, each zone being selected by using said control, and
each zone being smaller in size than the size of the display, a zone being selected to enlarge the area of the zone to a magnified size that enlarges the zone to more fully fill the display area;
wherein the display being shown has a set of different functions of display, and the control receives a selection of a zoom mode, where the zoom mode starts with a default setting that selects one of said zones as a function of which of said set of different functions of display are being shown on the display area.

12. The system as in claim 11, wherein the set of different functions of display on the display include at least viewing a video program, viewing a mode of display, adjusting a mode of display, viewing an application that is being executed by a computer associated with the display, and adjusting characteristics of the display.

13. The system as in claim 12, further comprising a memory storing a table, the table including multiple different functions including said different functions, and each function associated with a default zone on the display which is likely to be desired to be zoomed for each said function.

14. The system as in claim 11, wherein each zone overlapping by a specified amount with at least one adjacent zone which is adjacent on the display area to each said zone, so that each two adjacent zones magnify the overlapping amount of the display; and
each zone being labeled with a zone number,
where said control enables selecting zones on the display by receiving a zone number.

15. The system as in claim 14, wherein said control further enables selecting zones on the display by receiving data from a navigation key to navigate horizontally and vertically on the display, where each press of the navigation key selects an adjacent zone which is overlapped with a previously-selected zone.

16. The system as in claim 14, where each zone overlaps with an adjacent zone by 50%, such that each zone and another adjacent zone overlap in display area by 50%.

17. The system as in claim 11, further comprising a clue window being shown on the display when the zoom mode is selected, the clue window showing an indication of the display and an indication of a portion of the display which is being zoomed.

18. The system as in claim 8, wherein the clue window is shown for a specified number of seconds, and disappears after the specified number of seconds.

19. A method of controlling a display, comprising:
showing a display on a display area of a display,
using a control for selecting zones on the display for zooming to a larger magnification, each zone being selected by using said control,
each zone being smaller in size than the size of the display, a zone being selected to enlarge the area of the zone to magnified size that enlarges the zone to more fully fill the display area;
each zone overlapping by a specified amount with at least one adjacent zone which is adjacent on the display area to each said zone, so that each two adjacent zones magnify the overlapping amount of the display; and
each zone being labeled with a zone number,
using said control to enables selecting zones on the display by receiving a zone number from another control device.

20. The method as in claim 19, wherein said control further enables selecting zones on the display by receiving data from a navigation key from said another control device to navigate horizontally and vertically on the display, where each press of the navigation key selects an adjacent zone which is overlapped with a previously-selected zone.

21. The method as in claim 20, wherein the navigation key includes controls from arrow keys on said another control device in multiple directions.

22. The method as in claim 19, where each zone overlaps with an adjacent zone by 50%, such that each zone and another adjacent zone overlap in display area by 50%.

23. The method as in claim 19, wherein the display being shown has different functions, and the control receives a selection of a zoom mode, where the zoom mode starts with a default setting that selects one of said zones as a function of which of said different functions are being shown on the display area.

24. The method as in claim 23, wherein the different functions on the display include at least viewing a video program, viewing a mode of display, adjusting a mode of display, viewing an application that is being executed by a computer associated with the display, and adjusting characteristics of the display.

25. The method as in claim 24, further comprising storing a table, the table in a memory, the table including multiple different functions including said different functions, and each function associated with a default zone on the display which is likely to be desired to be zoomed for each said function.

26. The method as in claim 19, further comprising showing a clue window being shown on the display when a zoom mode is selected, the clue window showing an indication of the display and an indication of a portion of the display which is being zoomed.

27. The method as in claim 26, wherein the clue window is shown for a specified number of seconds, and disappears after the specified number of seconds.

28. The method as in claim 23, where the display enables displaying multiple different applications which are running on a computer associated with the display, and where each of the applications includes a default zone for zooming, where a default zone for zooming for a first of said applications is different than a default zone for zooming of a second of said applications.
